(19) United States
(12) Patent Application Publication
(10) Pub. No.: US 2010/0180462 A1
(43) Pub. Date: Jul. 22, 2010

(54) HOLDING ASSEMBLY AND METHOD OF USE

(76) Inventors: Christopher Adam Proskey, Des Moines, IA (US); Mark R. Hinshaw, West Des Moines, IA (US)

Correspondence Address: Christopher Adam Proskey, Capital Square, Suite 200, 400 Locust Street, Des Moines, IA, 50309, US

(21) Appl. No.: 12/691,458

(22) Filed: Jan. 21, 2010

Related U.S. Application Data
(60) Provisional application No. 61/146,140, filed on Jan. 21, 2009.

(51) Int. Cl. F26B 19/00; F26B 25/00

(52) U.S. Cl. 34/88; 34/239

(57) ABSTRACT

A holding assembly for reducing the bacteria on a washcloth. The bacteria reducing cleaning device holding assembly comprising: a housing; at least one fan connected to the housing; the fan electrically connected to a power source; a holding device connected to the housing for holding a cleaning device; and a control device connected to the fan such that when the control device is activated the fan moves air over the holding device thereby drying the cleaning device held by the holding device. This provides the advantage of providing a device to hold a user's washcloth after use that helps to dry the washcloth thus reducing the bacteria count on the washcloth.

### BACKGROUND OF THE INVENTION

This invention relates to a bacteria reducing holding assembly. More specifically, and without limitation, this invention relates to a bacteria reducing holding assembly for reducing bacteria on a cleaning device.

Many people like to use small towels for cleaning purposes. More specifically, many people like to use washcloths while standing at a sink as well as while in the shower to wash their face and body. This practice is very beneficial as the use of the washcloth improves the cleaning action and removal of dirt, makeup, oils and dead skin over washing without a washcloth. Additionally, many people like to use a dish rag to clean up around the kitchen or the bathroom. Inevitably, in this process, the washcloth gets wet and partially dirty—but most of the time the washcloth does not get dirty enough to prevent reuse of the washcloth. This presents the user with a problem as to what to do with the wet and partially dirty washcloth between uses.

If left unattended, a wet and partially dirty washcloth is a perfect breeding ground for many types of bacteria and fungus which are, at a minimum, unpleasant, if not dangerous to ones health. A high bacteria count can lead to the washcloth having a bad odor, discoloration or other unappealing characteristics that make a user not want to touch the washcloth. Additionally, cleaning with a washcloth that has a high bacteria count, smells bad or is discolored, flies in the face of the washcloth's intended purpose, which is to make things cleaner, as the user could unintentionally be spreading germs.

Unknowingly, many users simply drape a washcloth over the edge of a bath tub or sink after use. Although placing the washcloth in this position somewhat helps the washcloth to dry, the washcloth still remains wet for a long period of time thereby providing bacteria with a breeding ground during this extended wet period.

As an improvement many users attempted to ring-out the washcloth after use to rid the washcloth of excess moisture as the moisture accelerates or enables bacteria to proliferate. Although ringing-out the washcloth does reduce some moisture, the washcloth still remains wet thereafter and therefore enabled bacterial proliferation.

Alternatively, many users hung the washcloth over a hook, bar or stem of a faucet to help dry the washcloth out. Although this method helped dry the washcloth as the washcloth is mostly surrounded by air and therefore could dry by evaporation more efficiently, this method still allows the washcloth to remain wet for an extended period of time thereby allowing bacterial proliferation. This is especially true when the washcloth is frequently used with only short intervals between use where the washcloth does not completely dry.

Despite these advances in washcloth drying methods and technology, problems still exist. In particular, problems regarding providing a device and method to reduce the bacteria on a washcloth between uses have not been addressed.

Thus it is a primary object of the present invention to provide a device and method to reduce the bacteria on a washcloth that improves upon the state of the art.

Another object of the present invention is to provide a device to hold and dry a washcloth.

These and other objects, features, or advantages of the present invention will become apparent from the specification and claims.

### BRIEF SUMMARY OF THE INVENTION

The present invention is a holding assembly for reducing the bacteria on a washcloth. The bacteria reducing cleaning device holding assembly comprising: a housing; at least one fan connected to the housing; the fan electrically connected to a power source; a holding device connected to the housing for holding a cleaning device; and a control device connected to the fan such that when the control device is activated the fan moves air over the holding device thereby drying the cleaning device held by the holding device. This provides the advantage of providing a device to hold a user's washcloth after use that helps to dry the washcloth thus reducing the bacteria count on the washcloth.

### BRIEF DESCRIPTION OF THE DRAWINGS

FIG. 1 is a perspective view of a bacteria reducing fan assembly having a top housing with a fan and a UV light, and a hook for a holding device.

FIG. 1A is an elevation bottom view of a bacteria reducing fan assembly having a top housing with a fan and a UV light, with the hooks and the controls removed.

FIG. 2 is a perspective view of a bacteria reducing fan assembly having a top housing having a fan and a UV light that acts as a bar as a holding device.

FIG. 3 is a perspective view of a bacteria reducing fan assembly having a back housing having a fan and a UV light that acts as a bar as a holding device.

FIG. 4 is a perspective view of a bacteria reducing fan assembly having a top housing having a fan and a UV light, and a back housing having a fan and a UV light, a hook and a shelf for a holding device, and a base.

FIG. 5 is a perspective view of a bacteria reducing fan assembly having a fan in its base and a UV light in its housing, the housing being generally rectangular in shape.

FIG. 5A is a sectional elevation view of a bacteria reducing fan assembly having a fan in its base and a UV light in its housing, the housing being generally rectangular in shape.

FIG. 6 is a perspective view of a bacteria reducing fan assembly having a fan in its base and a UV light in its housing, with horizontal spacers being connected to the assembly at one end and to a suction cup at an opposite end.

### LIST OF REFERENCE NUMERALS AND TERMS

10—Bacteria Reducing Fan Assembly
12—Top Side
14—Bottom Side
16—Front Side
18—Back Side
20—Top Housing
22—Top Housing Top Surface
24—Top Housing Bottom Surface
26—Top Housing Back Surface
28—Top Housing Side Surfaces
30—Fan
32—Opening in Top Surface of Top Housing
34—Opening in Bottom Surface of Top Housing
35—Directive Ductwork
36—Light
38—Clear Light Covering Material.
40—Reflective Material
42—Suction Cup
44—Holding Device
46—Downwardly Extending Vertical Shaft
48—Hook
50—Shelf
52—Outwardly Extending Horizontal Section of Shelf
54—Vertically Extending Ledge Section of Shelf
56—Horizontally Extending Rod Section
56A—First Horizontally Extending Rod Section
56B—Second Horizontally Extending Rod Section
56A—Third Horizontally Extending Rod Section
58—Controls
60—“On” Button
62—“Off” Button
64—“Time” Dial
66—“Speed” Dial
68—“Light” Button
70—“Fan” Button
72—“Intensity” Dial
74—Holding Device Sensor
76—Moisture Sensor
78—“Dryness” Dial
79—Readout
80—Entry Space
82—Cleaning Device Housing
84—Cleaning Device Housing Top Position
86—Cleaning Device Housing Bottom Position
88—Horizontal Spacer
90—Back housing
92—Back Housing Top Surface
94—Back Housing Bottom Surface
96—Back Housing Front Surface
98—Back Housing Back Surface
100—Back Housing Side Surfaces
102—Base
104—Cleaning Device Housing Right and Left Sides
106—Cleaning Device Housing Front and Back Faces
108—Cleaning Device Housing Internal Space
110—Cleaning Device Housing Perforations
112—Base Air Inlet Openings
114—Divider
116—Base Bottom

### DESCRIPTION OF THE PREFERRED EMBODIMENT

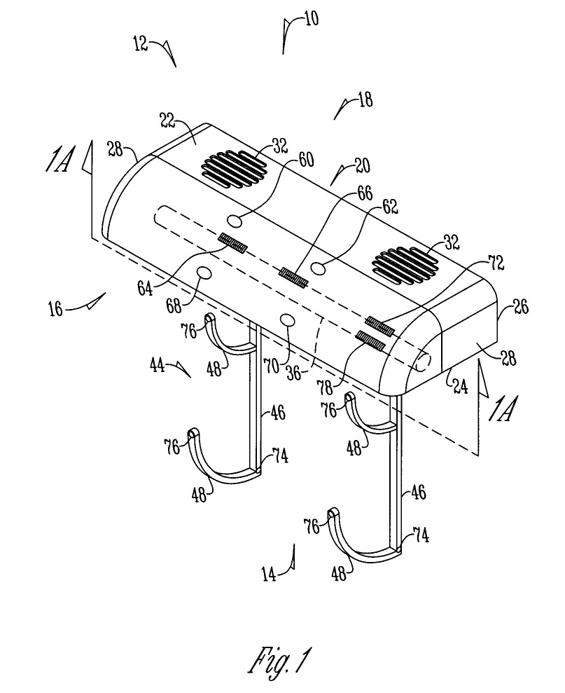

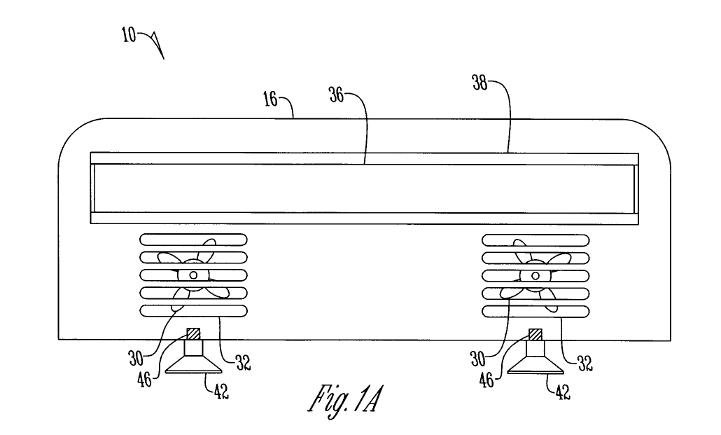

Referring to FIG. 1, a bacteria reducing cleaning device holding assembly 10 has a top side 12, a bottom side 14, a front side 16 and a back side 18. The bacteria reducing assembly 10 has a top housing 20. Top housing 20 has a top surface 22, a bottom surface 24, a back surface 26 and right and left side surfaces 28. The back surface 26 is generally vertical and therefore runs parallel to any wall surface the device 10 may be attached or adjacent thereto. The top surface 22 extends outwardly from the back surface 26 and gradually slopes downwardly in a generally curved and convex manner from the top of the back surface 26 forward to the front of the bottom surface 24 such that when used in a wet environment such as a shower, bathroom or kitchen, any water that hits the top surface 22 of top housing 20 will have a tendency to roll off of the device 10. The top housing 20 is preferably made of a plastic material. Alternatively, top housing 20 is made of any material which is structurally sound for its intended purpose.

Connected to and contained within top housing 20 is at least one fan 30. In a preferred embodiment, the air input, or top side, of fan 30 is connected to an opening 32 in the top surface 22 of top housing 20, through which air is sucked. Alternatively, the air input, or top side, of fan 30 is connected to an opening in the back surface 26 of top housing 20, through which air is sucked. The air output, or bottom side, of fan 30 is connected to an opening 34 in the bottom surface 24 of top housing 20, through which air is blown downwardly. The fan 30 is of any configuration which is known in the art. However, fan 30 is generally water proof, water resistant and/or humidity resistant as much of the fans intended use is in a wet or high moisture content environment. In a preferred embodiment, top housing 20 has two fans 30 symmetrically disposed with each fan's outside edge residing just within the side surface 28 of top housing 20, and its inside edge residing just outside of the center point of the top housing 20 with a space between the inside edges of the respective fans 30. These fans 30 reside just below the top surface 22 of top housing 20 with a space therebetween. Alternatively, top housing 20 has only one fan 30. Alternatively, top housing 20 has three or more fans. Preferably, fans 30 are aligned with a horizontal plain such that they blow downwardly. Alternatively, fans 30 are aligned with a vertical plain such that they blow horizontally. Alternatively, fans 30 are aligned at any angle to efficiently and effectively achieve their intended purpose. Also connected to top housing 20 is directive ductwork 35 which helps to direct the flow of air coming out of the fan 30 over its intended target. Directive ductwork 35 is present at the output end of fan 30 and provides a smooth surface over which air passes. In a preferred embodiment, ductwork 30 connects to the output end of fan 30 at one end and to the bottom 24 of top housing 20 at the other end, thereby helping to define the opening 34 in the bottom 24 of top housing 20. Alternatively, ductwork 35 is connected to any portion of top housing 20.

Connected to or contained within top housing 20 is at least one light 36. In a preferred embodiment light 36 is an ultraviolet fluorescent light which inhibits or kills bacteria, fungus and germs. Light 36 is of any configuration known in the art. Light 36 is generally straight and tubular and runs parallel across a substantial portion of the width of the device 10 just above the bottom surface 24 of top housing 20. Alternatively, light 36 is a fluorescent tubular light which is u-shaped, or rectangular-shaped and extends around the perimeter of the bottom surface of top housing 20. Alternatively, light 36 is an incandescent light, Light Emitting Diode (LED) or any other form of light emitting device which is known in the art.

Electrically connected to the fan 30 and light 36 is a power source. In a preferred embodiment the power source is contained within the top housing 20 and consists of a compartment which contains batteries which provide power as is old and known in the art. Alternatively, device 10 is electrically connected to an external power source, such as a wall plug in, by way of an electrical cord.

Light 36 is adjacent to the bottom surface 24 of housing 20 and shines outwardly and downwardly. In a preferred embodiment, light 36 is uncovered. That is, there is nothing covering the surface of light 36 such that the energy released from light 36 is uninhibited and travels directly out of light 36 to its intended target.

In an alternative embodiment, light 36 is covered by a clear light covering material 38 such as a glass, plastic, polycarbonate, or the like material, that is transparent to light (both visible and ultra violet) and does not greatly inhibit the light's ability to kill bacteria, fungus and germs. This light covering material 38 helps to provide a smooth surface plain and enclose the top housing 20 to maintain a clean and dry interior of top housing 20. Additionally, covering light 36 with light covering material 38 helps to extend the usable life of light 36 and keeps moisture off of the surface of light 36 and protects the electrical connections to light 36.

In a preferred embodiment, the light covering material 38 is connected to the bottom surface 24 of top housing 20 like a clear window in an opaque sheet of material. This connection is made by any means known in the art such as clipping the light covering material 38 into the bottom surface 24 of top housing 20 by mechanical means, sliding the light covering material 38 into a groove in the bottom surface 24 of top housing 20, welding the light covering material 38 to the bottom surface 24 of top housing 20, gluing the light covering material 38 to the bottom surface 24 of top housing 20, molding the light covering material 38 into the bottom surface 24 of top housing 20, or the like. Alternatively, the entire bottom surface 24 of top housing 20 is made of light covering material 38. Alternatively, light covering material 38 is formed as a sheath which covers the light 36. For example, in the embodiment where light 36 is a tubular fluorescent light, the light covering material 38 is a tube of clear material which fits over the surface of light 36 thereby protecting it, yet, due to the properties of light covering material 38, the affect and efficiency of the light 36 is not greatly inhibited.

Additionally, to improve the efficiency, accuracy and effect of light 36, reflective material 40 is placed within top housing 20 to direct light outwardly from top housing 20. This reflective material 40 is of any form known in the art such as a mirrored surface, a white reflective surface, or the like. In a preferred embodiment, reflective material is placed on or connected to the interior surface of top housing 20. Alternatively, the interior surface of top housing 20 is made of reflective material 40. Alternatively, reflective material 40 is adjacent to light 36 on a side of light 36 in which light emitted therefrom is not desired and therefore is redirected towards its intended target. Alternatively, reflective material 40 is connected to or painted onto a side of light 36 in which light emitted therefrom is not desired and therefore is redirected towards its intended target.

Connected to the back surface 26 of top housing 20 is at least one suction cup 42 for connection to a wall, a shower, a mirror or the like surfaces. This suction cup 42 is of any configuration known in the art and is connected to the back surface 26 of top housing 20 by any means known in the art such as being permanently welded thereto, being connected by a hole in the back surface 26 of top housing 20 which receives a groove in the suction cup 42, being connected by a nut and bolt or a screw through the back surface 26 of top housing 20, or being glued to the back surface 26 of top housing 20, or the like. In a preferred embodiment, a pair of suction cups 42 are symmetrically spaced across the back surface 26 of top housing 20 and connected thereto. Alternatively, a single suction cup 42 is used in the horizontal center of the back surface 26 of top housing 20. Alternatively, a plurality of suction cups 42 are connected to the back surface 26 of top housing 20. Alternatively, suction cups 42 are connected to any other portion of the device 10 such as the top surface 22, bottom surface 24, side surfaces 26 or the holding device 44 to name a few, to provide additional support for the device or additional ways to connect the device. In addition to providing support for device 10, the suction cup 42 provides a space between the back surface 26 of the top housing 20 and any wall, shower, mirror, or like surface, the device is connected thereto which allows for greater airflow around the top housing 20 of device 10. Alternatively, instead of a suction cup 42, top housing 20 is supported by any other supporting device known in the art such as an adhesive pad connected to the device 10, a screw or nail passing through or connected to a portion of device 10, or the like.

Connected to the top housing 20 is at least one holding device 44. In general terms, holding device 44 refers herein to any mechanical configuration capable of holding a cleaning device. With reference to FIG. 1, holding device 44 comprises a pair of downwardly extending vertical shafts 46 connected to a hook 48. The downwardly extending vertical shaft 46 at its top end is connected to the back surface 26 of top housing 20 and extends downwardly generally parallel to any wall, shower, mirror or other surface device 10 is connected thereto. Alternatively, vertical shaft 46 is connected to any other part of top housing 20. Hook 48 is connected to the bottom end of downwardly extending vertical shaft 46 and begins an arcuate outward upward extension therefrom which ends at a point which hangs free in space. In a preferred embodiment device 10 has a pair of hooks 48 symmetrically located, hanging below the top housing 20 and exposed to the outward expulsion of air from fans 30 and light from lights 36. Alternatively, device 10 has only a single hook 48. Alternatively, device 10 has a plurality of hooks 48. Hooks 48 are intended to hold a cleaning device such as a washcloth, dish rag, tooth brush, scrubby, sponge, luffa sponge, razor, or any other like device. In a preferred embodiment hooks 48 are specifically conformed to fit a particular cleaning device.

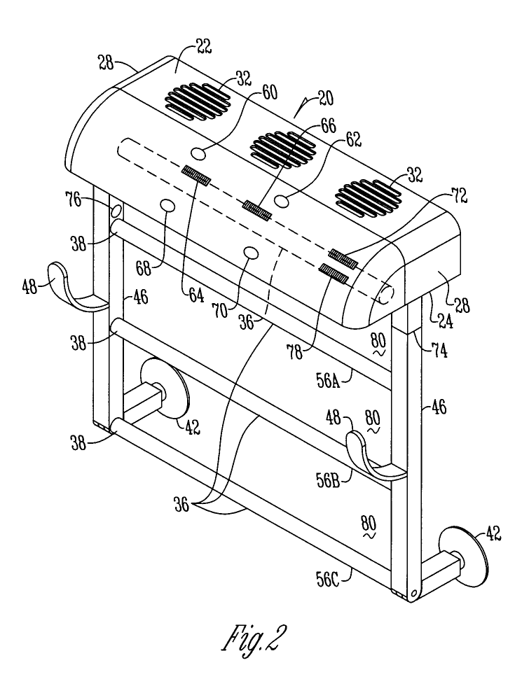

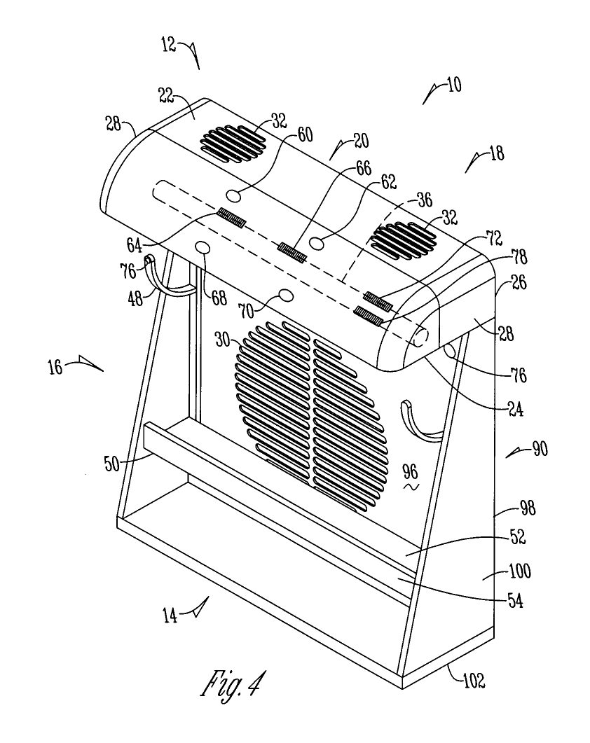

Alternatively, with reference to FIG. 4, holding device 44 consists of a shelf 50 which has an outwardly extending horizontal section 52 which ends in a vertically extending ledge section 54 intended to hold a cleaning device which is exposed to the outward expulsion of air from fans 30 and light from lights 36. Alternatively, with reference to FIG. 2, holding device 44 consists of a horizontally extending rod section 56 connected at its ends by downwardly extending vertical shaft 46 which is connected to side surfaces 28 of top housing 20. In a preferred embodiment, horizontally extending rod section 56 consists of a tubular fluorescent ultraviolet light 36 covered by light covering material 38 which is both transparent and provides support and protection to the light 36 and the electrical connections thereto. Light covering material 38 is connected to the downwardly extending vertical shaft 46, and in a preferred embodiment, is sealed thereto to protect light 36 from moisture, soap, shaving cream, tooth paste or other debris and contaminants often present in the intended use environment. Alternatively, holding device 44 consists of forks designed to hold such utensils as a handled scrub brush, tooth brush, razor, or the like device with at least one outward extension of the fork on either side of the head of the utensil. This design is especially useful when it mimics the proprietary shape of certain razor holders so as to hold the razor in place between uses in an optimum position to be quickly dried and disinfected by device 10.

Connected to the top housing 20 are controls 58. Controls 58 are present on the outside surface of top housing 20. Alternatively, controls 58 are present on any portion of device 10. Controls 58 consist of an “On” button 60 which turns the entire device on. Controls 58 consist of an “Off” button 62 which turns the entire device off. Controls 58 consist of a “Time” dial 64 which sets the amount of time the device is on after the on button 60 is depressed or the device is activated by other means. The time dial 64 allows the user to set a predetermined length of time the device 10 runs after being activated, from zero to infinity. Controls 58 consist of a “Speed” dial 66 which sets the speed of any fan 30 present on the device 10 from the slowest speed possible for that particular fan to the fastest speed possible for that particular fan. Controls 58 consist of a “Light” button 68 which activates or deactivates the light 36 when the device 10 is running. Controls 58 consist of a “Fan” button 70 which activates or deactivates the fan 30 when the device 10 is running. Controls 58 consist of an “Intensity” dial 72 which sets the intensity of the lights 36 present on the device 10 from the lowest possible intensity for that particular light to the highest possible intensity for that particular light. Alternatively, other controls and other functions for these controls are used.

Connected to the holding device 44 is a sensor 74 which senses when a cleaning device is present on the holding device 44. Alternatively, sensor 74 is connected to top housing 20 or any other part of the device 10. Sensor 74 is any configuration known in the art that senses the placement of an object on another object, or senses motion, such as a weight sensor, a motion sensor, a laser sensor, a spring sensor, a hydraulic sensor, a deflection sensor, or the like. When sensor 74 is activated by placing or replacing a cleaning device on the holding device 44, sensor 74 activates device 10 based on the settings of the controls 58. That is, when sensor 74 is activated the device 10 runs, if at all, based on whether the light button 68 and/or the fan button 70 is activated. If they are then the device 10 runs for the amount of time set by the time dial 64, the fans 30 run at the speed set by the speed dial 66, and the lights 36 burn at the intensity set by the intensity dial 72.

Additionally, other sensors, such as moisture sensor 76 are present on the holding device 44. Moisture sensor 76 is connected to the holding device 44 and comes into contact with cleaning device held by the holding device. Alternatively, moisture sensor 76 is present on any part of device 10 such as the top housing 20 and looks upon the cleaning device from a distance. Moisture sensor 76 senses the moisture content of the cleaning device present on the holding device 44. Moisture sensor 76 is connected to dryness dial 78. The user sets the level of dryness, from a minimum level of moisture to a maximum level of moisture. If the cleaning device exceeds the preset level of moisture, device 10 activates to dry and disinfect the cleaning device as set by controls 58.

Additionally, device 10 has a readout 79 which communicates a variety of information to the user. In a preferred embodiment, readout 79 is a screen, such as a liquid crystal display (LCD), a digital display such as is present on many cellular phones, electric razors, and similar devices, or the like. Readout 79 communicates the temperature, moisture content of the cleaning device, the settings of the device 10 set by controls 58, the amount of power left in the batteries if device 10 is battery powered, and other similar information. Alternatively, readout 79 is a light connected to a specified category of information, such as battery power, such that when the battery power goes below a certain threshold the light comes on indicating that the batteries are low. In a preferred embodiment, lights 36, fans 30, controls 58, sensors 74 and 76, readout 79 are electrically connected to the power source as well as to one another so as to facilitate proper functioning of device 10.

With reference to FIG. 2, in a slightly alternative embodiment, preferably connected at their top end to the side surfaces 28 of top housing 20 is a pair of downwardly extending vertical shafts 46 which run generally parallel to one another. Alternatively, downwardly extending vertical shafts 46 are connected to any portion of device 10. Downwardly extending vertical shafts 46 are in line with the axis of rotation of fans 30 and spaced between the front side 16 and back side 18 of top housing 20. Running horizontally between vertical shafts 46 and directly below and in line with the axis of rotation of fans 30 is at least one horizontally extending rod section 56. In a preferred embodiment, horizontally extending rod section 56 consists of a tubular fluorescent ultraviolet light 36 as described above. Between the first horizontally extending rod section 56A and the bottom surface 24 of top housing 20; between first horizontally extending rod section 56A and second horizontally extending rod section 56B; and between second horizontally extending rod section 56B and third horizontally extending rod section 56C is an entry space 80 which allows removal and replacement of a cleaning device, such as a washcloth to be hung over the horizontally extending rod section 56. This plurality of rod sections 56 with corresponding entry spaces 80 allows multiple users to hang different cleaning devices, such as washcloth s, over each respective horizontally extending rod section 56A, 56B, 56C. Alternatively, in the case where only one cleaning device, such as a washcloth, is hung over the first horizontally extending rod section 56A and each horizontally extending rod section 56A, 56B, 56C consists of a tubular fluorescent ultraviolet light 36, this exposes the cleaning device to the radiation from all three horizontal rod sections 56A, 56B, 56C, thereby increasing the antibacterial and antifungal affect. Alternatively, there are more than three horizontally extending rod sections 56. Alternatively, there are less than three horizontally extending rod sections 56.

Alternatively, a cleaning device housing 82 is created by having a sheet of material, such as clear light covering material 38, connected at its exterior edges to the downwardly extending vertical shafts 46 running from a cleaning device housing top position 84 to a cleaning device housing bottom position 86 thereby defining an enclosed space therein. Contained within the cleaning device housing 82 is at least one light 36. In a preferred embodiment, light 36 is a tubular florescent light which runs horizontally between downwardly extending vertical shafts 46. Alternatively, light 36 is a tubular florescent light which runs vertically, or at any other angle between downwardly extending vertical shafts 46. Alternatively, light 36 is any other light as described above.

Cleaning device housing 82 provides a surface upon which a cleaning device is draped and thereby supported. Covering lights 36 with a sheet of material and creating a cleaning device housing 82 provides the lights 36 with an extra layer of protection. See also FIG. 82 for an alternative embodiment of a cleaning device housing 82.

Connected to the bottom end of downwardly extending vertical shafts 46 is horizontal spacer 88. Horizontal spacer 88 connects at its forward end to downwardly extending vertical shafts 46 and to a wall, shower, mirror or similar surface at its rearward end. When the device 10 of FIG. 2 is connected at its upper end by suction cup 42 to a wall, shower, mirror or similar surface, horizontal spacer 88 helps to maintain device 10 in a generally vertical and upright position as well as provide stabilization and support. Alternatively, horizontal spacer 88 connects to a suction cup 42 at its rearward end which connects to a wall, shower, mirror or similar surface so as to provide additional support for device 10 as well as maintain device 10 in a generally vertical and upright position. Alternatively, horizontal spacer 88 extends outwardly from device 10 at any angles so as to properly stabilize and support device 10.

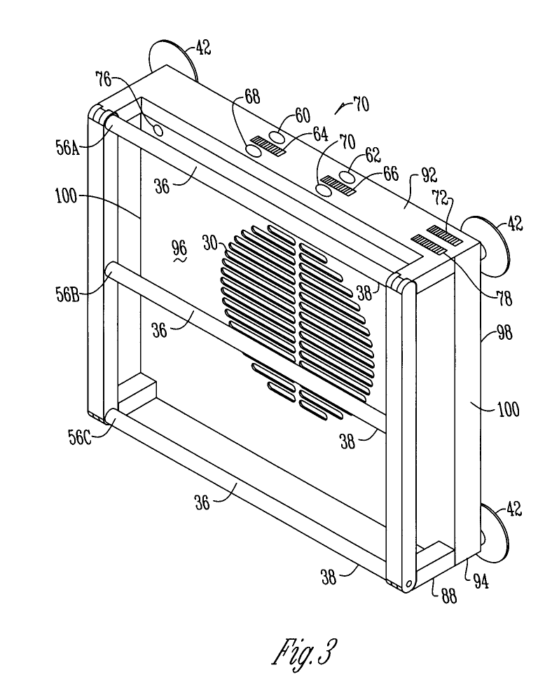

With reference to FIG. 3, in an alternative embodiment, bacteria reducing cleaning device holding assembly 10 has a back housing 90. Back housing 90 has a top surface 92, a bottom surface 94, a front surface 96, a back surface 98 and right and left side surfaces 100. The back surface 98 is generally vertical and therefore runs parallel to any wall surface the device 10 is attached or adjacent thereto. The front surface 96 is generally vertical as well. The top surface 92 is generally arcuately shaped so as to allow water residing on the top surface 92 to quickly roll off. Alternatively, top surface 92 is angled for the same affect. Located near the center of the back housing 90 is a single fan 30. Alternatively, back housing 90 contains a plurality of fans 30. Fan 30 sucks air from behind the device 10 through an opening in the back surface 98 of the back housing 90 and blows air forward through an opening in the front surface 96 of back housing 90. In front of and connected to the back housing 90 is holding device 44. Connected near the top surface 92 of back housing 90, and bottom surface 94 of back housing 90 at or near side surfaces 100 are horizontal spacers 88. Horizontal spacers 88 connect at their back end to back housing 90 and extend outwardly therefrom in a generally horizontal fashion. Horizontal spacers 88 connect at their forward end to downwardly extending vertical shafts 46. Running between horizontal spacers 88 are horizontally extending rod sections 56. In a preferred embodiment three horizontal rod sections 56 are present, one near the top of downwardly extending vertical shafts 46, one near the bottom of downwardly extending vertical shafts 46 and one near the center of downwardly extending vertical shafts 46 such that a cleaning device, such as a washcloth, can be draped over each horizontal rod section 56. Alternatively, a cleaning device housing 82 is present between the downwardly extending vertical shafts 46 providing a single surface over which to drape a cleaning device, such as a washcloth. Alternatively, holding device 44 consists of at least one hook 48 connected to the front surface 98 of back housing 90.

Connected to the back surface 98 of back housing 90 is at least one suction cup 42. In a preferred embodiment, a suction cup 42 is placed in each corner of the generally square back surface 98 of back housing 90. Alternatively, a single suction cup 42 is used. Alternatively, a plurality of suction cups 42 are connected to the back surface 98 of back housing 90. Alternatively, as previously discussed, other connection devices and methods are used or the like.

With reference to FIG. 4, bacteria reducing cleaning device holding assembly 10 has both a top housing 20, as previously described, and back housing 90, as previously described. Top housing 20 is connected at or near its back side 18 and bottom side 14 to the top surface 92 and back surface 98 of back housing 90 thereby spacing top housing 20 to hang forwardly over back housing 90. Alternatively, top housing 20 and back housing 90 are connected by any portion of each device. This arrangement allows the fans 30 and lights 36 in top housing to blow and shine down upon holding device 44 while at the same time fans 30 and lights 36 in back housing 90 blow and shine outwardly over holding device 44. Holding device 44 is connected to the front surface 96 of back housing 90. Alternatively, holding device 44 is connected to the bottom side 14 of top housing 20. Alternatively, holding device 44 is connected to any other portion of device 10.

Connected to the bottom surface 94 of back housing 90 is base 102 which extends downwardly and outwardly so as to counter act the weight of top housing 20 so as to balance and support the device 10 in an upright position. Base 102 is permanently connected 10 back housing 90. Alternatively, base 102 is removably attached to back housing 90. Despite the presence of base 102, device 10 can still be hung by suction cups 42 connected to the back surface 98 of the back housing 90, or any other alternative hanging device described herein. The combined affect of a top housing 20 and back housing 90 in a single device 10 provides added drying and antibacterial and antifungal affect on a cleaning device.

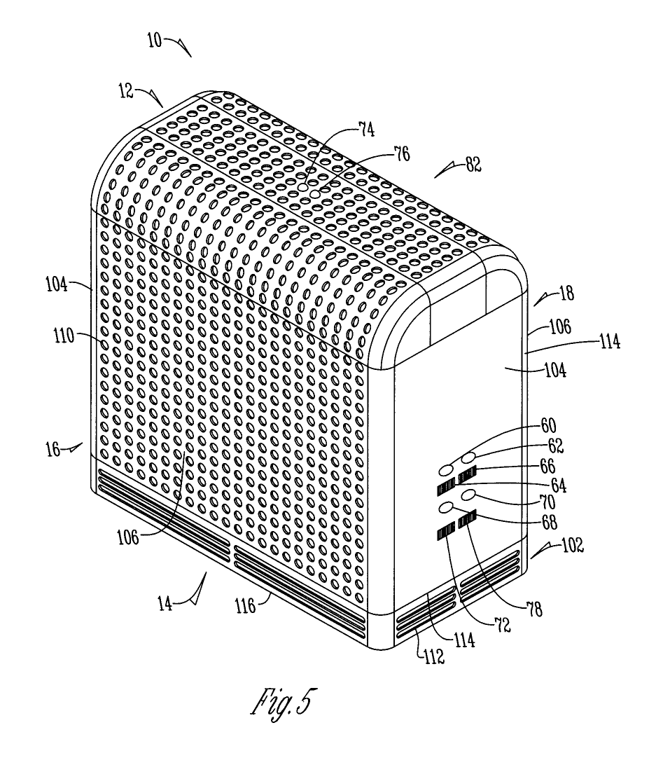

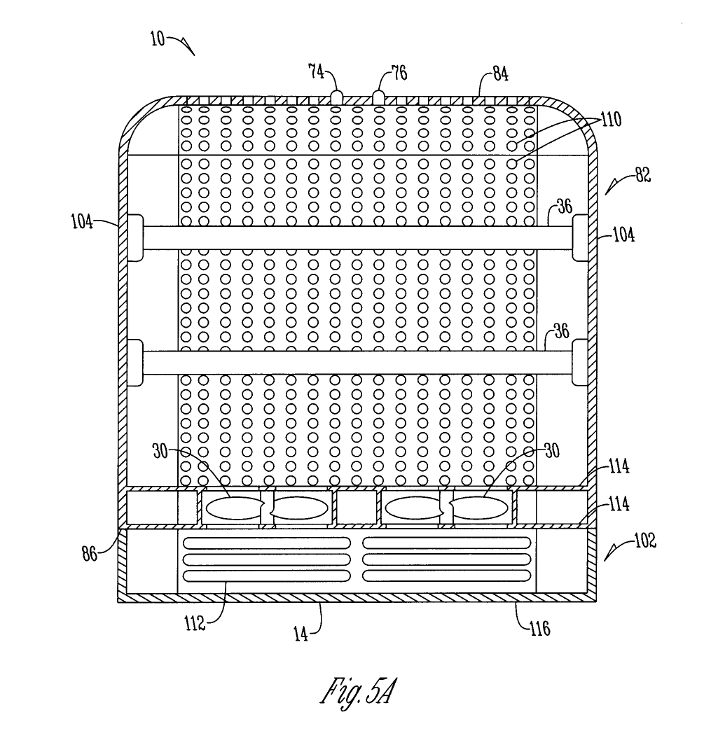

In an alternative embodiment, with reference to FIG. 5, bacteria reducing cleaning device holding assembly 10 has a cleaning device housing 82 which acts as a holding device 44. Cleaning device housing 82 is designed to receive a cleaning device, such as a washcloth, on its exterior surface, by draping the cleaning device over the cleaning device housing 82. Cleaning device housing 82 has a cleaning device housing top position 84, a cleaning device housing bottom position 86, cleaning device housing side surfaces 104, and cleaning device housing front and back faces 106. Cleaning device housing 82 is removably connected to a base 102 at cleaning device housing bottom position 86. In a preferred embodiment, cleaning device housing 82 is generally symmetric. Side surfaces 104 of cleaning device housing 82 extend upwardly from base 102 to top position 84 in a generally vertical manner with a slight slant inwardly. Faces 106 of cleaning device housing 82 extend upwardly from base 102 having a first generally vertical portion transitioning into an arcuately and convexly curving portion that ends at top position 84. Device 10 is generally wider from side surface 104 to side surface 104 than it is deep from face 106 to face 106. Device 10 is generally taller from cleaning device housing bottom position 86 to cleaning device housing top position 84 than it is deep from face 106 to face 106. Faces 106 and sides 104 smoothly connect to one another with rounded edges defining a cleaning device housing internal space 108. Preferably, device 10 stands upon the flat bottom surface of base 108.

Contained within cleaning device housing internal space 108 is a network containing a plurality of lights 36, as previously described. In a preferred embodiment, cleaning device housing contains three fluorescent ultraviolet lights 36 that run horizontally parallel to one another in a vertically stacked fashion, 56A, 56B, 56C. Alternatively, only one light 36 is contained within cleaning device housing 82. Alternatively, cleaning device housing 82 contains any configuration of lights 36.

Cleaning device housing 82 is preferably made of a rigid plastic material, as previously described. In a preferred embodiment, cleaning device housing 82 is made of a clear light covering material 38 such that ultraviolet light from lights 36 can easily pass therethrough thereby disinfecting any cleaning device draped over cleaning device housing 82. In a preferred embodiment, cleaning device housing front and back faces 106 contain a plurality or a pattern of perforations 110 to allow air to pass therethrough. This pattern of perforations 110 is intended to mimic where a cleaning device, such as a washcloth, would be present when draped over the cleaning device housing 82 so as to facilitate quicker drying of the cleaning device. In a preferred embodiment, cleaning device housing side surfaces 104 are solid and continuous, and do not contain any perforations 110. Alternatively, perforations 110 are present over other portions of the device 10. Also, in a preferred embodiment, a side surface 104 contains controls 58 as previously described which control the device 10. Alternatively, controls 58 are present on one of the faces 106, on the base 102 or anywhere on device 10.

Removably connected to and matingly received at the bottom position 86 of the cleaning device housing 82 is base 102. This removability allows base 102 and cleaning device housing 82 to be separated from one another so as to facilitate cleaning of the device 10 including interior surfaces. Alternatively, base 102 and cleaning device housing 82 are permanently connected by fusing, welding, gluing, molding as a single piece, or the like processes. Base 102 extends downwardly from cleaning device housing 82 generally following the same footprint of the cleaning device housing 82 thereby defining an interior space therein. Air inlet openings 112 are present in the outside surface of the downward extension of base 102. Divider 114 is present at the interface between the top of base 102 and bottom of cleaning device housing 82. Divider 114 acts as a ceiling and a floor and separates the internal space of cleaning device housing 82 and base 102. The divider 114 is preferably connected to top of base 102. Alternatively, the divider 114 is connected to the bottom of cleaning device housing 82. Alternatively, the divider 114 is present at any position of device 10 thereby separating the internal space of base 102 and cleaning device housing 82. At the opposite side of base 102 is the bottom 116 of base 102 which supports the device 10 in an upright position. Bottom 116 of base 102 is preferably a closed end. Alternatively, bottom 116 of base 102 is an open end. Alternatively, bottom 116 of base 102 has perforations in it. Alternatively, bottom 116 of base 102 has legs which the device 10 stands upon. Connected to an opening in the divider 114 is at least one fan 30 such that when the fan 30 is activated it moves air from one compartment 102 or 82 to the other compartment 102 or 82. In a preferred embodiment there are two fans 30. Alternatively, there is a plurality of fans 30. In a preferred embodiment, when activated, fan 30 sucks air through air inlet openings 112 in the sidewall of base 102 and blows this air through the cleaning device housing internal space 108 and out cleaning device housing perforations 110 thereby drying any wet cleaning device such as a washcloth draped over the cleaning device housing 82.

Additionally, the device 10 contains a holding device sensor 74, as previously described. In a preferred embodiment, holding device sensor 74 is a pressure sensor located at the interface of the holding device housing 82 and base 102. Alternatively, the sensor 74 protrudes through the external surface of the cleaning device housing 82. Alternatively, the sensor is placed anywhere on device 10. Therefore, when a cleaning device is placed on cleaning device housing 82, the weight of the cleaning device is sensed by the holding device sensor 74 thereby activating the device 10 as previously described. Alternatively, an optical sensor, laser sensor, light sensor, or the like is used that senses when a cleaning device such as a washcloth is placed over the cleaning device housing 82 thereby activating the device 10. Preferably in this embodiment sensor 74 is located in, or protruding through, the external surface of the cleaning device housing 82. Alternatively, this sensor 74 is located within the cleaning device housing 82 and looks through the cleaning device housing 82.

Also contained within cleaning device housing 82 is a heating device (not pictured), such as a heating coil or other similar device as is known in the art. The heating device increases the temperature of the air passed through or over the holding device 44 so as to increase the speed of drying said cleaning device. Also, the device 10 also contains a moisture sensor as previously described.

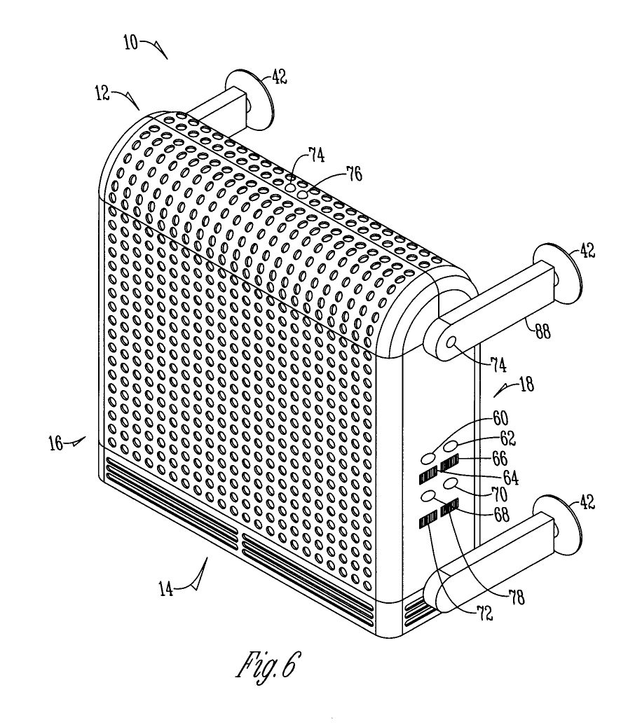

The embodiment of FIG. 6 is similar to that of FIG. 5. The embodiment of FIG. 5 is intended to be freestanding on a countertop, sink or bathtub ledge. In this embodiment air is sucked through the air inlet openings 112 in the downwardly extending sidewalls of base 102. In contrast, the embodiment of FIG. 6 is intended to be attached to a wall, mirror, shower or like surface, with the addition of horizontal spacers 88. This attachment to a wall, mirror, shower or like surface allows the base 102 to have air inlet openings 112, not only in the downwardly extending sidewalls of base 102, but also in the bottom 116 of base 102 so as to allow air to pass therethrough. In a preferred embodiment, the forward end of horizontal spacers 88 are connected to the right and left sides 104 of the cleaning device housing 82 as well as the right and left sides of base 102. Alternatively, horizontal spacers 88 are connected to only one of the cleaning device housing 82 and base 102. Alternatively, horizontal spacers 88 are connected to any portion of device 10 so as to provide support for the device 10. The back end of horizontal spacers 88 are connected to a suction cup 42, or similar device, so as to facilitate connection and support to a wall, mirror, shower or like surface. In a preferred embodiment holding device sensor 74 is connected to the cleaning device housing 82. In an alternative embodiment, sensor 74 is connected to the horizontal spacer 88 and thereby senses the placement and replacement of a cleaning device. In a preferred embodiment, horizontal spacers 88 are removable so as to convert the device 10 between the embodiments of FIG. 5 and FIG. 6.

In operation, with reference to the embodiment of FIG. 1, a user takes bacteria reducing cleaning device holding assembly 10 having suction cups 42 connected to the back surface 26 of top housing 20 and engages the suction cups 42 to a wall, shower, mirror or like surface thereby hanging the device from said surface in a generally vertical fashion which is parallel to said surface. Alternatively, the device 10 is hung on a nail, screw, or like attachment device thereby suspending the device 10 in similar fashion. If the device is battery operated device the user places batteries in the designated compartment of the top housing 20 (not pictured). Alternatively, if the device is powered by an external power source, such as a plug in, the user plugs in the device 10 by way of an electric cord which is connected to the top housing 20.

Next, the user reviews the controls 58 present on the exterior surface of top housing 20, setting the controls 58 to the user's desired manner of operation. The user turns the device 10 on by pressing the on button 60. The user turns the device 10 off by pressing the off button 62. The user sets the amount of time the user wants the device to run when activated by holding device sensor 74 by setting the time dial 64 from a minimum time to a maximum time. The user sets the speed dial 66 between a minimum speed to a maximum speed which affects the speed at which the fans 30 run which affects the level of energy consumed, the efficiency of the device 10, the amount of noise the device 10 generates, and how long it takes to dry a cleaning device. The user sets the light button 68 which affects whether the lights 36 come on when the device 10 is activated. The user sets the fan button 70 which affects whether the fans 30 come on when the device 10 is activated. The user sets the intensity dial 72 from a minimum to a maximum which affects the intensity at which the lights 36 burn when activated, the level of energy consumed, the efficiency of the device 10, and the antibacterial affect of device 10. The user sets the dryness dial 78 from a minimum dryness to a maximum dryness which is connected to moisture sensor 76 such that when moisture sensor 76 senses that the cleaning device exceeds the user-set level of dryness the device 10 activates to dry the cleaning device.

The user places a cleaning device such as a washcloth on the holding device 44 by hanging said washcloth over the end of hook 48 such that gravity holds said cleaning device in place as it drapes thereover and downwardly. Hook 48 is supported by downwardly extending vertical shaft 46.

The user then activates device 10 by pressing the on button 60. Alternatively, device 10 is activated by sensor 74, which in a preferred embodiment is a weight sensor connected to holding device 44 which is connected to dryness dial 78. When a cleaning device is placed onto the holding device 44, weight sensor 74 senses the placement of the cleaning device which activates device 10. Device 10 then runs until the weight of the cleaning device lessens (because of evaporation of moisture contained in the cleaning device) by a predetermined amount as set by the dryness dial 78. Alternatively, device 10 is activated by moisture sensor 76 which is connected to dryness dial 78. Moisture sensor 76 monitors the moisture content of the cleaning device either by direct contact or from a distance, and activates the device 10 when the moisture content of the cleaning device exceeds the preset level. Device 10 then runs based on the preset controls 58. The moisture sensor 76 turns the device 10 off when the moisture content of the cleaning device falls below the level set by the dryness dial 78.

Fans 30 activate based upon fan button 70 at the speed set by the speed dial 66. When activated fans 30 pull air from the opening in the top surface 32 of top housing 20 and blow said air downwardly through the opening in the bottom surface 34 of top housing 20. This air comes into contact with directive ductwork 35 and is thereby efficiently channeled in a preferred direction as it passes through top housing 20, over holding device 44 and any cleaning device held thereby. This blown air increases the evaporation rate of water thereby having a drying affect on the moist cleaning device.

Lights 36 activate based upon light button 68 at the intensity set by the intensity dial 72. When lights 36 activate they shine outwardly from light 36. Some of the light passes directly through light covering material 38. Other light reflects off of reflective material 40 and is redirected through light covering material 38. The light covering material is transparent to the light and therefore does not greatly affect the intensity. The directed light shines outwardly and downwardly over holding device 44 and into contact with any cleaning device held thereby. This ultraviolet light has an antibacterial and antifungal affect as it kills bacteria, fungus and germs.

The device 10 runs until the user presses the off button 62. Alternatively, the device 10 runs until the device has run for the preset amount of time as set by the time dial 64. Alternatively, the device 10 runs until the preset level of moisture is achieved as set by the dryness dial 78 and detected by the moisture sensor 76. Alternatively, the device 10 runs until the preset level of dryness is achieved as set by the dryness dial 78 and detected by the holding device sensor 74. Alternatively, the device 10 runs until the holding device sensor 74 or moisture sensor 76 detect that the cleaning device has been removed.

In operation, in the alternative embodiment of FIG. 2, cleaning device 10 is supported by suction cups 42 connected to the back surface 26 of top housing 20 and hangs therefrom. The device 10 is further supported by horizontal spacer 88 connected to the bottom end of downwardly extending vertical shaft 46 which also contains a suction cup 42 at its back end which connects to a wall, mirror, shower, or like surface and adds stability to the lower end of device 10. The user passes a portion of the cleaning device such as a washcloth through entry space 80 between top housing 20 and first horizontally extending rod section 56A. The user then drapes the cleaning device over first horizontally extending rod section 56A. The cleaning device hangs therefrom and preferably hangs past second and third horizontally extending rod sections 56B, 56C. When device 10 is activated, fans 30 blow air downwardly across the exterior surface of the cleaning device thereby drying it. Additionally, lights 36 which are contained in the horizontally extending rod sections 56A, 56B, 56C, shine outwardly through clear light covering material 38 and onto the interior surface of the cleaning device thereby killing any fungus or bacteria the light comes into contact with.

In a preferred embodiment, a sheet of material covers all three horizontally extending rod sections 56 such that a cleaning device cannot be passed through the space between the first 56A and second 56B, or the second 56B and the third 56C horizontally extending rod sections 56. This sheet of material helps define cleaning device housing internal space 108 which allows the distribution of light from lights 36 to more evenly reach the internal surface of a single cleaning device hung thereover.

Alternatively, entry spaces 80 are present between the first 56A and second 56B, and between the second 56B and the third 56C, horizontally extending rod sections 56 which allows the user to pass second and third cleaning devices through these entry spaces 80 such that device 10 supports three cleaning devices. When activated, the fans 30 blow air downwardly over all three cleaning devices. The light 36 contained within the first horizontally extending rod section 56A emanates light which interacts with at least the portion of the first cleaning device which comes into contact with and hangs over the first horizontally extending rod section 56A. The light 36 contained within the second horizontally extending rod section 56B emanates light which interacts with at least the portion of the second cleaning device which comes into contact with and hangs over the second horizontally extending rod section 56B. The light 36 contained within the third horizontally extending rod section 56C emanates light which interacts with at least the portion of the third cleaning device which comes into contact with and hangs over the third horizontally extending rod section 56C.

In operation, in the alternative embodiment of FIG. 3, cleaning device 10 is supported by suction cups 42 connected to the back surface 98 of back housing 90. These suction cups are connected to a wall, shower, mirror or other like surface thereby suspendedly supporting the device. These suction cups 42 provide a small space between the back surface 98 of the back housing 90. The user hangs a cleaning device such as a washcloth over the first horizontally extending rod section 56A. When activated, the fan 30 sucks air from the space behind the back housing 90 and blows it forwardly towards the holding device 44. This blown air first contacts the back-most back facing surface of the cleaning device and blows thereover thereby drying it. The lights 36 contained within the horizontally extending rod sections 56 emanate light outwardly which first contacts the interior side of the cleaning device which is draped over the horizontally extending rod sections 56. Additionally, the lights 36 contained within the back housing 90 emanate light outwardly through clear light covering material 38 which first contacts the back-most back facing surface of the cleaning device thereby disinfecting the cleaning device. The device 10 is activated by the user interacting with controls 58 preferably connected to top surface 92 of the back housing 90. Alternatively, device 10 is activated by one of the sensors 74, 76.

In operation, in the alternative embodiment of FIG. 4, cleaning device 10 stands upwardly upon base 102. This embodiment is essentially a standing combination of the previous embodiments of FIGS. 1 and 3. Device 10 is activated by the user engaging controls 58, preferably present on the exterior surface of top housing 20, or alternatively present on any portion of device 10. Alternatively, device 10 is activated by the placement or replacement of a cleaning device on a holding device 44 such as hook 48 or shelf 50 as sensed by sensors 74, 76. When activated the fans 30 in the top housing 20 suck air from above device 10 and blows downwardly over the holding device 44. Additionally, the fan 30 in the back housing 90 sucks air from behind device 10 and blows outwardly over the holding device. This combination of air blowing outwardly and downwardly helps to increase the speed at which a wet cleaning device placed on a holding device 44 of device 10 dries.

Additionally, device 10 contains a plurality of lights 36. Preferably these lights are tubular fluorescent lights. The light 36 present in the top housing shines downwardly over the holding device 44. The lights 36 present in the back housing 90 shine outwardly over the holding device 44. This combination of light from above and behind the holding device 44 helps to increase the antibacterial affect of device 10.

In operation, in the alternative embodiment of FIG. 5, a user places device 10 on the bottom 116 of base 102 such that the device 10 stands upright. The user then places a cleaning device such as a washcloth over the exterior surface of the cleaning device housing. The washcloth is centered between the right and left sides 104 and is centered over the top position 84 of the cleaning device housing 82 and hangs downwardly therefrom evenly over the front and back faces 106 of the cleaning device housing. Preferably, the device is sized to receive a standard sized washcloth thereby allowing the washcloth to cover most if not all of the perforations 110 in the cleaning device housing 82 while not having a large amount of surface area where there are no perforations 110. Spacing the perforations 110 evenly across the surface area of the washcloth allows for quicker and more efficient drying.

The holding device sensor 74 senses the presence of the cleaning device and activates the device 10. Alternatively, an optical sensor, light sensor or laser sensor senses the presence of the cleaning device and activates the device 10. Alternatively, the moisture sensor 76 senses that the cleaning device has too high a moisture content and activates the device 10. Alternatively, the user activates the device 10 by interacting with the controls 58.

When activated, the fans 30 suck air through the air inlet openings 112 in the base 102. This air passes from the internal space in the base 102 and is blown by the fans 30 into the internal space of the cleaning device housing 82. This air then passes through perforations 110 in the cleaning device housing and over or through any washcloth that is hung over the cleaning device housing 82. This blown air dries the cleaning device. Additionally, cleaning device housing 82 heater warms the air and thereby increases the speed at which the cleaning device is dried.

Simultaneously, the network of lights 36 contained within the cleaning device housing 82 illuminate and shine outwardly. This light passes through the generally transparent cleaning device housing 82 and engages the surface of the cleaning device hung over the cleaning device housing 82. Due to the shape of the cleaning device housing 82 this light reaches the entire interior surface of the cleaning device thereby efficiently disinfecting it. After completing the drying and disinfecting cycle, the cleaning device housing 82 continues to hold the cleaning device until the next use.

In operation, in the alternative embodiment of FIG. 6, which is similar to the embodiment of FIG. 5, with the modifications that the device is suspended from a wall, shower, mirror or like surface. In operation, the user connects suction cups 42 to a mirror, shower, wall or similar surface thereby supporting the device in a suspended fashion. When activated, air is sucked through the air inlet openings 112 in the sides of base 102 as well as in the bottom 116 of base 102. This air is then blown through the cleaning device housing 82, through perforations 110 and through or over the cleaning device.

From the above discussion it will be appreciated that bacteria reducing cleaning device holding assembly 10 described herein provides a novel, useful and non-obvious solution to holding, drying and disinfecting a cleaning device. Accordingly, the bacteria reducing cleaning device holding assembly 10 described herein offers many advantages over the prior art including providing a novel device and method for holding, drying and disinfecting a cleaning device that can be used in the kitchen, shower, bathroom or like area that provides accelerated drying and disinfecting of the cleaning device.

Although this invention has been described primarily to be used with a cleaning device such as a washcloth, this device is not limited to only washcloth s and similar devices. The dimensions of this device can be modified to fit any shaped device, such as a towel, razor, sponge, scrubby or like devices. Additionally, although this device has been described generally as an independent and freestanding removable device, device 10 is permanently affixable to any component. Therefore, it will be appreciated by those skilled in the art that other various modifications could be made to the device without parting from the spirit and scope of this invention. All such modifications and changes fall within the scope of the claims and are intended to be covered thereby.

We claim:

1. A bacteria reducing cleaning device holding assembly comprising:
a top side;
a bottom side;
a front side;
a back side;
a housing;
at least one fan connected to the housing;
the fan electrically connected to a power source;
a holding device connected to the housing for holding a cleaning device; and
a control device connected to the fan such that when the control device is activated the fan moves air over the holding device thereby drying the cleaning device held by the holding device.

2. The holding assembly of claim 1 further comprising:
the fan positioned above the holding device.

3. The holding assembly of claim 1 further comprising:
the fan positioned behind the holding device.

4. The holding assembly of claim 1 further comprising:
the housing positioned above the holding device.

5. The holding device of claim 1 further comprising:
at least one suction cup connected to the device.

6. The holding assembly of claim 1 further comprising:
the holding device being a hook.

7. The holding assembly of claim 1 further comprising:
the holding device being a bar.

8. The holding assembly of claim 1 further comprising:
the device having a light connected to the housing.

9. The holding assembly of claim 1 further comprising:
the device having a sensor to detect when a cleaning device is present on the holding device.

10. The holding assembly of claim 1 further comprising:
the device having a base connected to the housing.

11. The holding assembly of claim 1 further comprising:
a back housing connected to a top housing.

12. A bacteria reducing cleaning device holding assembly comprising:
a top side;
a bottom side;
a front side;
a back side;
a housing;
at least one fan connected to the housing;
a base connected to the housing;
the base having at least one inlet opening to allow air to pass there through; and
the housing having at least one outlet opening to allow air to pass there through.

13. A bacteria reducing cleaning device holding assembly comprising:
a top side;
a bottom side;
a housing;
a base;
the assembly comprising the housing connected to the base;
the assembly having an inlet side and an outlet side;
the assembly having a divider between the inlet side and the outlet side;
a fan connected to the assembly;
at least one opening in the inlet side of the assembly to allow air to pass there through; and
at least one opening in the outlet side of the assembly to allow air to pass there through.

14. The holding assembly of claim 13 further comprising:
the outlet side of the assembly having at least a portion that is transparent.

15. The holding assembly of claim 13 further comprising:
the outlet side of the housing having a light.

16. The holding assembly of claim 13 further comprising:
a sensor connected to the device to detect when a cleaning device is placed on the housing.
